(19) United States
(12) Patent Application Publication
(10) Pub. No.: US 2007/0033356 A1
(43) Pub. Date: Feb. 8, 2007

(54) System for Enabling Secure and Automatic Data Backup and Instant Recovery

(76) Inventor: Boris Erlikhman, Mountain View, CA (US)

Correspondence Address: CENTRAL COAST PATENT AGENCY, INC, 3 HANGAR WAY SUITE D, WATSONVILLE, CA, 95076, US

(21) Appl. No.: 11/462,260

(22) Filed: Aug. 3, 2006

Related U.S. Application Data
(60) Provisional application No. 60/705,227, filed on Aug. 3, 2005.
(60) Provisional application No. 60/708,911, filed on Aug. 17, 2005.

(51) Int. Cl. G06F 12/16

(52) U.S. Cl. 711/162

(57) ABSTRACT

A host-based system for enhancing performance for a computing appliance has a central processing unit, an operating system, a long-term disk storage medium, and a persistent low latency memory (PLLM). Writes to disk storage at random addresses are first made to the PLLM, which also stores a memory map of the disk storage medium, and later made, in sequence, to the disk storage medium according to the memory map. In another aspect the host-based system is for continuous data protection and backup for a computing appliance, and has a central processing unit, an operating system, a long-term disk storage medium, and a persistent low latency memory (PLLM). In this aspect periodic system state snapshots are stored in the PLLM associated with sequence of writes to memory made between snapshots, enabling restoration of the host to any state of a prior snapshot stored in the PLLM, and then adjustment, via the record of writes to memory between snapshots, to any state desired between the snapshot states.

### CROSS-REFERENCE TO RELATED APPLICATIONS

The present invention claims priority to a U.S. provisional patent application Ser. No. US60/705227 filed on Aug. 3, 2005 entitled, “On-Host Continuous Data Protection, Recovery, Heterogeneous Snapshots, Backup and Analysis”, and to a U.S. provisional patent application Ser. No. US60/708,911 filed on Aug. 17, 2005 entitled “Write performance optimization implemented by using a fast persistent memory to reorganize non-sequential writes to sets of sequential writes”. The listed disclosures are included herein at least by reference.

### BACKGROUND OF THE INVENTION

1. Field of the Invention

The present invention is in the field of computer-generated (Host or Appliance) data backup, protection, and recovery and pertains particularly to methods and apparatus for data mapping, and optimizations for hierarchical persistent storage management, including fault tolerant data protection and fine grain system snapshot and instant recovery.

2. Discussion of the State of the Art

In the field of protection and restoration of computer generated data, it is important to protect computer systems from individual personal computers (PCs) to robust enterprise server systems from data loss and system down time that may result from system or application failure. The enterprise and medium businesses are especially vulnerable to loss of efficiency resulting from a lack of a secure data protection system or a faulty or slow data protection and recovery system. Small businesses require reliable and automated (shadow) backup to compensate lack of experienced IT personal and unreliable backup.

Existing methods for protecting data written to various forms of storage devices include copying files to alternate or secondary storage devices. Another known method involves archiving data to storage tape. In some systems, “snapshots” of data are created periodically and then saved to a storage disk for later recovery if required. Some data storage, backup, and recovery systems are delivered as external data protection devices (appliances), meaning that they reside outside of the processing boundary of the host.

There are some problems and limitations with current methods for protecting system and host generated data. For example, magnetic tape used in tape-drive archival systems suffers from poor performance in both data write and data access. Archiving data to tape may slow system activity for extended periods of time. Writing data to tape is an inherently slow process. Data restoration from a tape drive is not reliable or practical in some cases. One reason for this is that data on tape resides in a format that must be converted before the mounting system recognizes the data.

One development that provides better performance than a tape archival system uses high capacity serial-advanced-technology attachment (SATA) disk arrays or disk arrays using other types of hard disks (like SCSI, FC or SAS). The vast majority of on-disk backups and advanced data protection solutions (like continuous data protection) use specialized, dedicated hardware appliances that manage all of the functionality. Although these appliances may provide some benefits over older tape-drive systems, the appliances and software included with them can be cost prohibitive for some smaller organizations.

One mitigating factor in the data protection market is the speed at which systems can write the data into protective storage. Systems often write their data to some long term storage devices such as a local disk drive or a networked storage device. Often this data may be associated with one or more application programs and is located in random locations within the long term storage device(s). Writing frequently to random storage locations on a disk storage device may be slow because of seek-time and latency inherent in disk drive technology, more particularly, for each write the disk drive physically moves its read/write head and waits for the appropriate sector to come into position for write.

Data protection and backup appliances currently available handle data from several production servers and typically use SATA hard disks, which are much slower than SCSI hard disks. Improved performance can be achieved by adding additional disks, however cost becomes a factor.

Data writing performance, especially in robust transaction systems, is critical to enterprise efficiency. Therefore it is desired to be able to secure increasing amounts of data and to continually improve writing speed. Therefore, what is clearly needed are methods and apparatus that enable continuous data protection (CDP) for computing systems while improving write performance and solving the problems inherent to current systems described above (including slow and unreliable data recovery).

### SUMMARY OF THE INVENTION

In an embodiment of the invention a host-based system for continuous data protection and backup for a computing appliance is provided, comprising a central processing unit, an operating system, a long-term disk storage medium, and a persistent low latency memory (PLLM). Writes to disk storage are first made to the PLLM, and later (being coalesced) made to the disk storage medium on the snapshot basis.

In one embodiment of the system periodic system state snapshots are stored in the PLLM, enabling restoration of the host to any state of a prior snapshot stored in the PLLM, and then adjustment, via the record of writes to memory between snapshots, to any state desired between the snapshot states.

In some embodiments the PLLM is non-volatile, random access memory (NVRAM), Flash memory, Magnetic RAM, Solid-state disk or any other persistent low latency memory devices.

In another aspect of the invention a method for improving performance in a computerized appliance having a CPU and non-volatile disk storage is provided, comprising steps of: (a) providing a persistent low-latency memory (PLLM) coupled to a CPU and to the non-volatile disk storage; (b) storing a memory map of the non-volatile disk storage in the PLLM; (c) performing writes meant for the disk storage first to the PLLM; and (d) performing the same writes later from the PLLM to the non-volatile disk, but in a more sequential order determined by reference to the memory map of the disk storage.

In one embodiment of the method steps are included for (e) storing periodic system state snapshots in the PLLM; and (f) noting sequence of writes to the PLLM for time frames between snapshots, enabling restoration to any snapshot, and any state between snapshots.

In some embodiments of the method the PLLM is non-volatile, random access memory (NVRAM), Flash memory, Magnetic RAM, Solid-state disk or any other persistent low latency memory devices.

### BRIEF DESCRIPTION OF THE DRAWING FIGURES

FIG. 1 is a block diagram illustrating a host computing system enhanced with a persistent memory according to an embodiment of the present invention. Further, persistent memory can be any type of low latency persistent storage devices such as non-volatile memory (NVRAM), Flash memory, Magnetic RAM, Solid-state disk, or combination of some of them.

FIG. 2 is a block diagram illustrating the computing system of FIG. 1 further enhanced with a snapshot storage pool.

FIG. 3 is a block diagram illustrating sequential writing of data into a production storage disk and a snapshot storage pool according to an embodiment of the present invention.

FIG. 4 is a block diagram of a persistent memory of a computing system and a mapping utility for addressing an incoming random write sequentially onto a hard disk according to an embodiment of the present invention.

FIG. 5 is a block diagram of the persistent memory of FIG. 4 including several mapping utilities for addressing a plurality of incoming random writes sequentially onto the hard disk of FIG. 4.

FIG. 6 is a block diagram illustrating components of the persistent memory of FIG. 4 and FIG. 5 handling a write request according to an embodiment of the present invention.

FIG. 7 is a block diagram illustrating components of the persistent memory handling a read request according to an embodiment of the present invention.

FIG. 8 is a block diagram illustrating a computing system optimized for fast writing and reading according to an embodiment of the present invention.

FIG. 9 is a block diagram illustrating system core utility components implemented in software according to an embodiment of the present invention.

FIG. 10 is a block diagram illustrating the system of FIG. 8 enhanced for backup data storage and failover protection according to an embodiment of the present invention.

FIG. 11 is a block diagram illustrating a controller for integrating a computing system to redundant array of independent disks (RAID) called ‘hybrid solution’ according to an embodiment of the invention.

FIG. 12 is a block diagram illustrating connection architecture for establishing data connectivity between a primary computing system and backup computing system for high-availability.

FIG. 13 is a block diagram of a server replicating data for backup and protection by a specialized appliance enhanced with persistent storage and data addressing for sequential writing according to an embodiment of the present invention.

FIG. 14 is a process flow chart illustrating acts for data recovery (switching to alternative storage or rolling back to a last good system snapshot) and instant application resume according to an embodiment of the present invention.

FIG. 15 is a block diagram illustrating a plurality of recent snapshots held in persistent memory according to an embodiment of the present invention.

FIG. 16 is a block diagram illustrating a data retention with persistent memory and integrated to a secondary storage system according to another embodiment of the present invention.

### DETAILED DESCRIPTION

Advanced Data Protection With Persistent Memory:

The inventor provides a computing system that can perform cost effective continuous data protection (CDP) and instant data recovery using a novel approach whereby a low latency persistent memory (PLLM or just PM) is provided to cache system snapshots during processing and to enable faster read and write access. The methods and apparatus of the invention are explained in enabling detail by the following examples according to various embodiments of the invention.

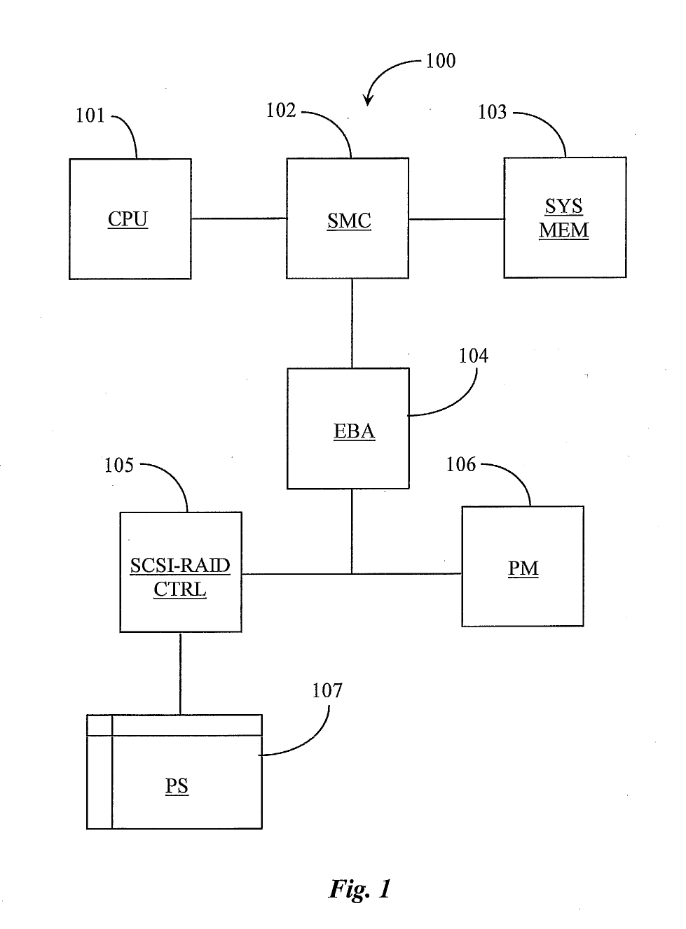

FIG. 1 is a block diagram illustrating a host computing system 100 enhanced with a persistent memory according to an embodiment of the present invention. Persistent memory can be any type of low latency persistent storage devices such as non-volatile memory (NVRAM), Flash memory, Magnetic RAM, Solid-state disk, or combination of some of them. System 100 may be analogous to any type of computing system from a PC system to an enterprise transaction server. In this example, system 100 includes a central processing unit (CPU) 101. CPU 101 utilizes a volatile system memory (SYS MEM) 103, which may be random access memory, and a system memory controller (SMC) that controls CPU access and utilization of memory 103 for normal data caching.

System 100 further includes an expansion bus adapter (EBA) 104 connected to SMC 102. EBA 104 provides CPU adaptation for an expansion bus. Common expansion buss configurations include Peripheral Component Interconnect (PCI) or variations thereof such as PCI-X and PCI-Express.

System 100 further includes a small computer system interface (SCSI)/redundant array of independent disks (RAID) controller 105, or optionally some other disk controller such as advanced technology attachment or a variant thereof. The exact type of controller will depend on the type of disk that computing system 100 uses for production storage (PS) 107. PS 107 may be a SCSI disk or variants thereof.

Controller 105 controls CPU access to PS 107 through expansion bus adapter 104. System 100 is provided with a persistent memory (PM) 106, which in one embodiment is a non-volatile random access memory (NVRAM). Persistent memory is defined within the specification as a memory type that retains data stored therein regardless of the state of the host system. Other types of persistent memory are Flash memory, of which there are many types known and available to the inventor, Magnetic RAM or Solid-state disk.

PM 106 may be described as having a low latency meaning that writing to the memory can be performed much faster than writing to a traditional hard disk. Likewise reading from NVRAM or Flash memory may also be faster in most cases. In this particular example, PM 106 is connected to CPU 101 through a 64-bit expansion bus.

Unique to computing systems is the addition of PM 106 for use in data caching for the purpose of faster writing and for recording system activity via periodic snapshots of the system data. A snapshot is a computer generated consistent image of data and system volumes as they were at the time the snapshot was created. For the purpose of this specification a snapshot shall contain enough information such that if computing system 100 experiences an application failure, or even a complete system failure, the system may be restored to working order by rolling back to a last snapshot that occurred before the problem. Furthermore, several snapshots of specific volume can be exposed to the system concurrently with the volume in-production for recovery purposes. Snapshots are writeable. It means that application and File System can write into snapshot without destroying it. It allows specifically providing application consistent snapshots. Snapshots can be used for different purposes such as specific file(s) or an entire volume(s) recovery. Writeable snapshots can be also used for test environment.

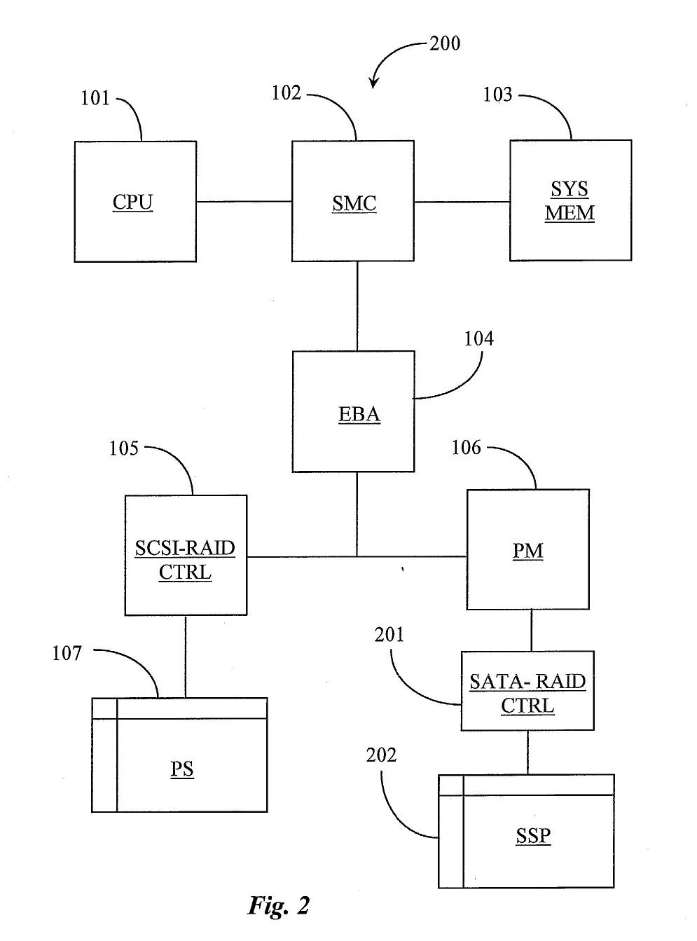

FIG. 2 is a block diagram illustrating the computing system of FIG. 1 further enhanced with a snapshot storage pool. A computing system 200 is provided in this example and includes all of the components previously introduced in system 100. Components illustrated in system 200 that were introduced in the description of FIG. 1 shall retain the same element numbers and description and shall not be reintroduced.

System 200 is provided with a SATA RAID controller 201 that extends the capabilities of the system for data protection and automatic shadow backup of data. In this example, snapshots cached in persistent memory (PM) 106 are flushed at a certain age to a snapshot storage pool (SSP) 202. SSP 202 is typically a SATA disks or disks staked in a RAID system. Other types of hard disks may be used in place of a SATA disk without departing from the spirit and scope of the present invention. Example include, but are not limited to advanced-technology attachment (ATA), of which variants exist in the form of serial ATA (SATA) and parallel ATA (PATA). The latter are very commonly used as hard disks for backing up data. In actual practice, SSP may be maintained remotely from system 200 such as on a storage area network (SAN) accessible through LAN or WAN within network attached storage (NAS). SSP is an extension of PM that can keep snapshots for day and weeks. SSP can also be used for production storage failover.

Being created once SSP is constantly and automatically updated in the background. SSP is an asynchronous consistent in time image of data and/or system volume(s).

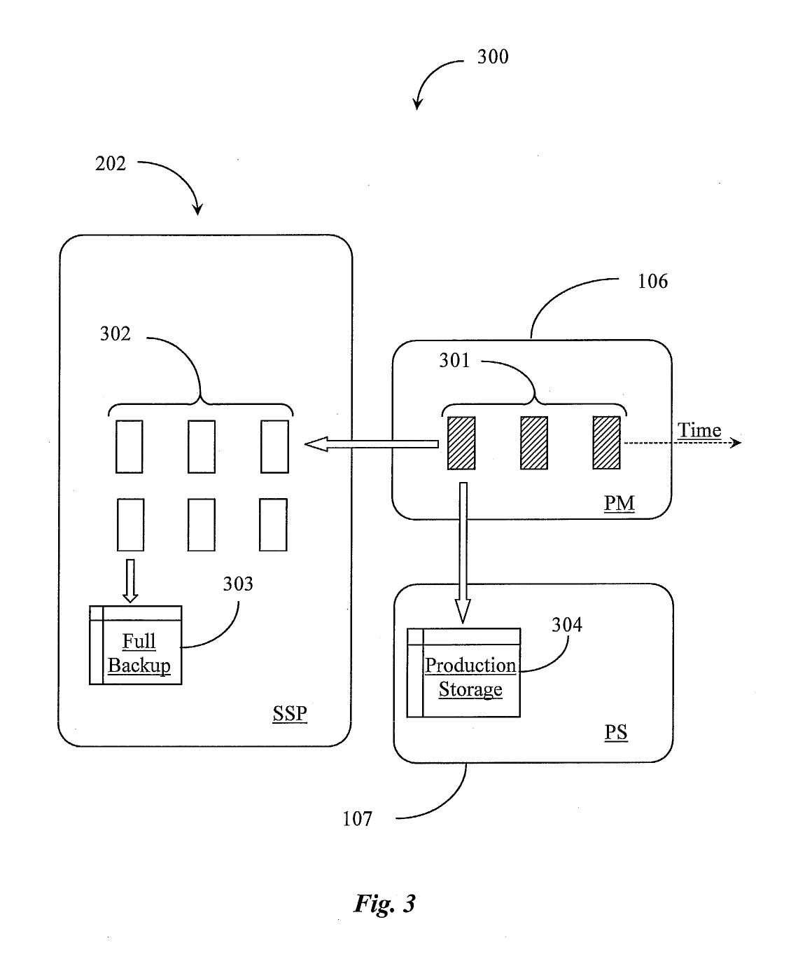

FIG. 3 is a block diagram illustrating sequential writing of data into a production storage disk and a snapshot storage pool according to an embodiment of the present invention. System 300 is illustrated in this example with only the storage facilities and PM 106 visible to more clearly point out the interaction between those facilities. Writes from the File System are redirected into PM analogous to described above, come into PM 106 over the previous figure.

The data is written into the persistent memory, using the memory as a sort of write cache instead of writing the data directly to the production storage and, perhaps replicating the writes for data protection purposes. The novel method of caching data uses allocate-on-write technique instead of traditional copy-on-write. Three major factors improve application performance: write-back mode (report write completion to the File System when data has been written into PM 106), write cancellation (keeping in PM latest version of the data), and writes coalescing (coalescing continuous and near-continuous blocks of data for efficient writing into production storage). The initial data writes are addressed to random locations on disk 304. However, a utility within PM 106 organizes the cached data in form of periodically taken snapshots 301. PM 106 contains short term snapshots 301 each taken at a different time. Snapshots 301 are taken over time so the oldest of snapshots 301 is eventually flushed into production storage 304 and snapshot storage pool 202.

Snapshots existing within PM 106 at any given time are considered short-term snapshots in that they are accessible from PM in the relatively short term (covering hours of the system activity). Snapshots 302 illustrated within snapshot storage pool 202 are considered long term snapshots because they are older or aged out of on-PM snapshots covering days and week of the system activity. All of snapshots 302 are eventually written to a full backup storage disk 303. A snapshot is generated arbitrarily as data is written therefore one snapshot may reflect much more recent activity than a previous snapshot.

One with skill in the art will recognize that NVRAM or other persistent memory may be provided economically in a size so as to accommodate many system snapshots before those snapshots are flushed from NVRAM (PM) 106 into PS 304 and SSP 202. Therefore, the host system has access to multiple system snapshots locally to which expedites instant data recovery greatly.

Most recent snapshots are stored on low latency persistent memory such as NVRAM or other mentioned types of low latency persistent memory devices. Older snapshots are stored on hard disks such as SATA disks. It is noted herein that common snapshot management is provided regardless of where the snapshots reside whether it be on PM 106 or on SSP 202. The system of the invention offers storage redundancy, for example, if production storage has failed, a production server can switch immediately to the alternative storage pool and resume its normal operation.

Write Optimization:

The inventor provides a write optimization that includes intermediate caching of data for write to disk using the low latency persistent memory as described above and utilities for organizing randomly addressed data into a sequential order and then mapping that data to sequential blocks on the disk. This method of writes does not provide advanced data protection like CDP. However, it is used within data protection appliances for random writes optimization. Such appliances handle data writes mostly and handle data reads periodically and infrequent for backing up and data recovery only. This unique write optimization technology is detailed below.

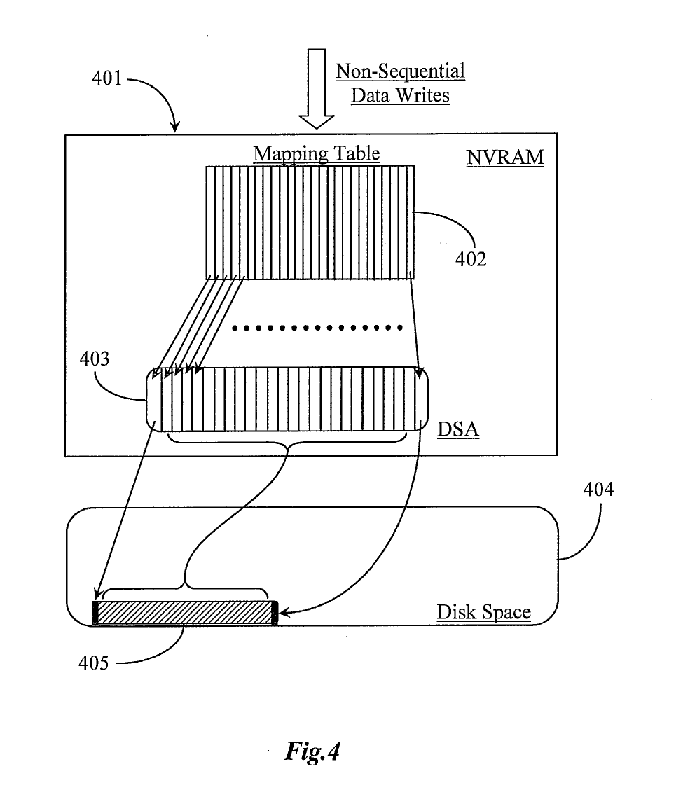

FIG. 4 is a block diagram of a persistent memory 401 of a computing system and a mapping utility 402 for mapping incoming random writes sequentially onto a hard disk according to an embodiment of the present invention. Typically for database applications (like Microsoft Exchange Server, MsSQL and Oracle) and general purpose File Systems data is written in random fashion into address locations that have to be sought both to write and to read in normal computing systems in current art. In this example, the utility of the provision of NVRAM 401 enables correlation of random addresses of data via mapping table 402 to a series of sequential addresses so that it may be written sequentially on a hard disk. A utility is provided within NVRAM 401 that organizes the write data and creates the mapping for writing the data (described further below). In actual practice, non-sequential data are mapped into a sequential data storage area or structure (DSA) 403 contained within NVRAM 401. Disk storage 404 is managed on a cluster basis. Each cluster is contiguous region within disk space that is written at once. A series of data blocks within cluster represent the sequential write 405 assembled in NVRAM 401. It will be clear to one with skill in the art that fewer sequential writes to disk space 404 may be completed in a much shorter time than more random data writes. It may also be clear then that one sequential write operation may take the place of several random write operations normally performed without the aid of the present invention.

Note that writing random data sequentially causes data fragmentation that may impact read performance. However, read performance is not critical for data protection appliances.

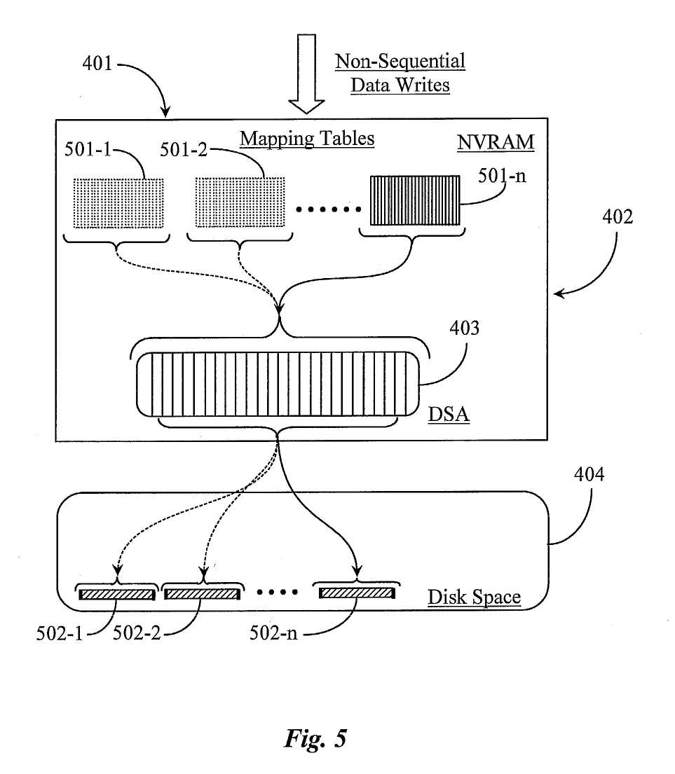

FIG. 5 is a block diagram of persistent memory 402 of FIG. 4 including several mapping utilities for mapping a plurality of incoming random writes sequentially onto the hard disk of FIG. 4. In this example, mapping tables 501-1 through 501-n are created within NVRAM 402, one for each aggregation of random data writes that will be come a sequential data write to disk 404. At each aggregation, the data is organized into a substantially sequential order in data storage area (DSA) 403 of NVRAM 402 in order of performance. Therefore, mapping table 501-1 contains the addressing correlation information for the data collected and prepared for sequential write 502-1 on disk space 404. Sequential write 502-2 corresponds to the data addressed by mapping table 501-2 and so on. Sequential write 502-n is just written in this example and is the most recent data written to production storage. The mappings tables are retained and updated as required and are used to locate data addresses for requested read operations.

One with skill in the art will recognize that the methodology of mapping random writes into a substantially sequential order can also be performed in parallel within NVRAM 402. In this way one sequential write may be initiated before another is actually finished. This capability may be scalable to an extent according to the provided structures and data capacity within NVRAM 402. Likewise, parallel processing may be performed within NVRAM 402 whereby collected data over time is mapped, structured using separate DSAs and written in distributed fashion over a plurality of storage disks. There are many possible architectures.

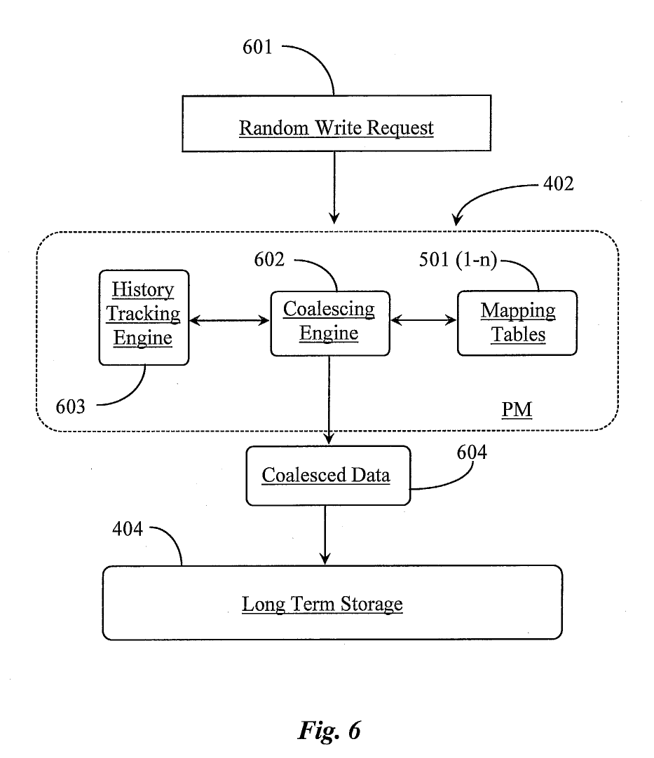

FIG. 6 is a block diagram illustrating components of the persistent memory of FIG. 4 and FIG. 5 handling a write request according to an embodiment of the present invention. A write request 601 comes into persistent memory 402, which may be NVRAM or Flash or some other combination of persistent memory as long as low latency characteristics are present.

PM 402 includes a coalescing engine 602 for gathering multiple random writes for sequential ordering. In a preferred embodiment, coalescing engine 602 creates one mapping table for every data set comprising or filling the data storage area (DSA). It is noted herein that the DSA may be pre-set in size and may have a minimum and maximum constraint on how much data it can hold before writing.

Furthermore as time progresses and more data is written into long term storage, more sets of data have been reorganized from non-sequential to sequential or near sequential data. Therefore, different sets of reorganized data could contain data originally intended to be written to the same original address/location in destination storage. In such a case only the last instance of data intended to be written to a same original address would contain current data. In this embodiment, the address translation tables resident in persistent memory may be adapted to recover locations that contain current data. In this way old data intended for the same original location may be discarded and the storage space reused. In this example, PM 402 has an added enhancement exemplified as a history tracking engine 603. Tracking engine 603 records the average frequency of data overwrites to a same address in memory as just described.

In order to avoid fragmenting data, a special algorithm is provided for garbage collection. The algorithm (not illustrated here) is based on the history of data update frequency logged by engine 603 and it coalesces data with identical update frequencies. Additional address translation and advanced “garbage collection” algorithm require storing additional information in the form of metadata within NVRAM 402. In this embodiment, each original write request results in several actual writes into long term persistent storage (disks) as a “transaction series” of writes.

The advanced form of “garbage collection” begins by identifying blocks of data that are frequently overwritten over time. Those identified blocks of data are subsequently written together within the same sequential data set. Arranging the locality of data blocks that are most frequently overwritten as sequential blocks within the sequential data set increases the likelihood that overwritten data will appear in groups (sequential blocks) rather than in individual blocks. History of past access patterns will be used to predict future access patterns as the system runs.

Referring now back to FIG. 6, coalesced data 604 is data that is structured in a substantially sequential order in terms of addressing for write to disk. The data is written to long-term storage disk 404. In this embodiment, reference to long-term storage simply differentiates from NVRAM storage.

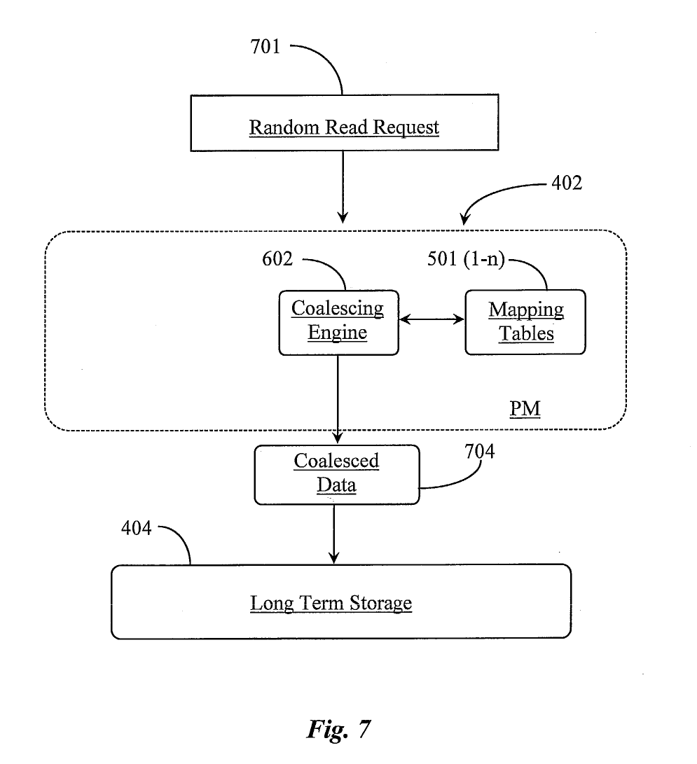

FIG. 7 is a block diagram illustrating components of persistent memory 402 handling a read request according to an embodiment of the present invention. By random, it is meant that the data subject to the read request is identified by its random address. Coalescing engine 602 consults with existing mapping tables to correlate the random read address with the relevant DSA (coalesced data 704) that contains required data block. Required data will be read from long term storage 404.

It is noted herein that the address correlation method described herein may, in a preferred embodiment, be transparent to the host CPU. The CPU only recognizes the random address for writes and reads and the utilities of the invention residing within PM 402.

Data Flow And Snapshot Management:

The inventor provides a detailed data flow explanation those results in advanced data protection, high-availability and data retention. These novel approaches whereby a low latency persistent memory, local snapshot storage pool and remote snapshot storage pool that keep (uniformly accessed) snapshots. Each snapshot can be exposed as a volume for the Operating System and used in read-write mode for production or for data recovery. However, original snapshot will be preserved. The methods and apparatus of the invention are explained in enabling detail by the following examples according to various embodiments of the invention.

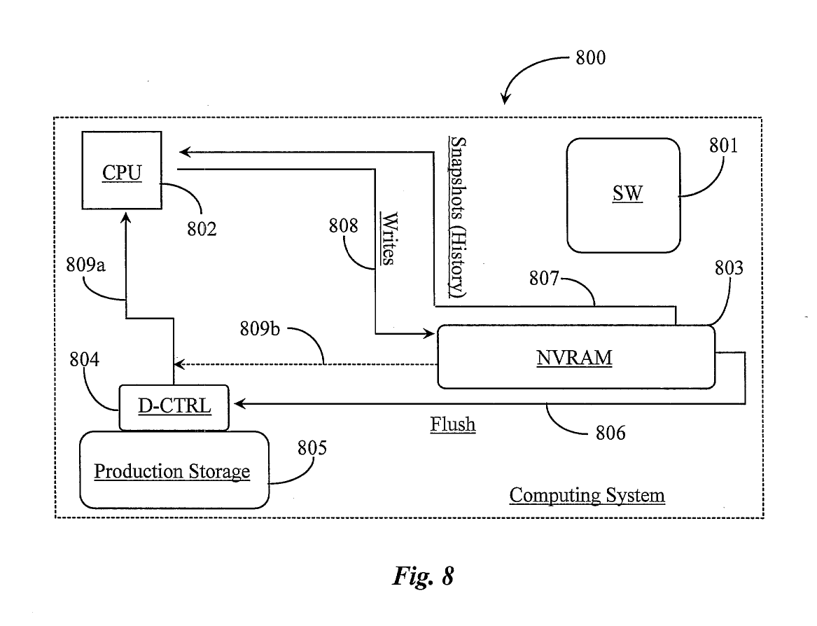

FIG. 8 is a block diagram illustrating a computing system 800 optimized for fast writing and reading according to an embodiment of the present invention. System 800 includes software 801. Software 801 is, in a preferred embodiment, embedded in part into the system kernel and is implemented in the form of drivers. System 800 includes a CPU 802, a persistent memory (NVRAM) 803, and production storage disk 805. Disc 805 is accessible through a disk controller 804.

In practice of the invention onboard computing system 800, CPU 802 aided by SW 801 sends write data to NVRAM 803 over logical bus 808. NVRAM 803 aided by SW 801 gathers write data in form of consistent snapshots. The data is then written into local production storage. Data snapshots are created and maintained within NVRAM 803 to an extent allowed by an aging scheme. Multiple snapshots are created and are considered fine grain snapshots while existing in NVRAM 803 and cover hours of the system activity. When a snapshot ages beyond NVRAM maintenance, it is flushed into production storage 805 through controller 804 over a logical path 806 and labeled flush.

Snapshots are available on demand from NVRAM 803 over a logical path 807. Application or File System may read directly from production storage disk 805 (through controller) over a logical path 809a, or optionally directly from NVRAM 803 over a logical path 809b. In this case, NVRAM 803 functions as a read cache.

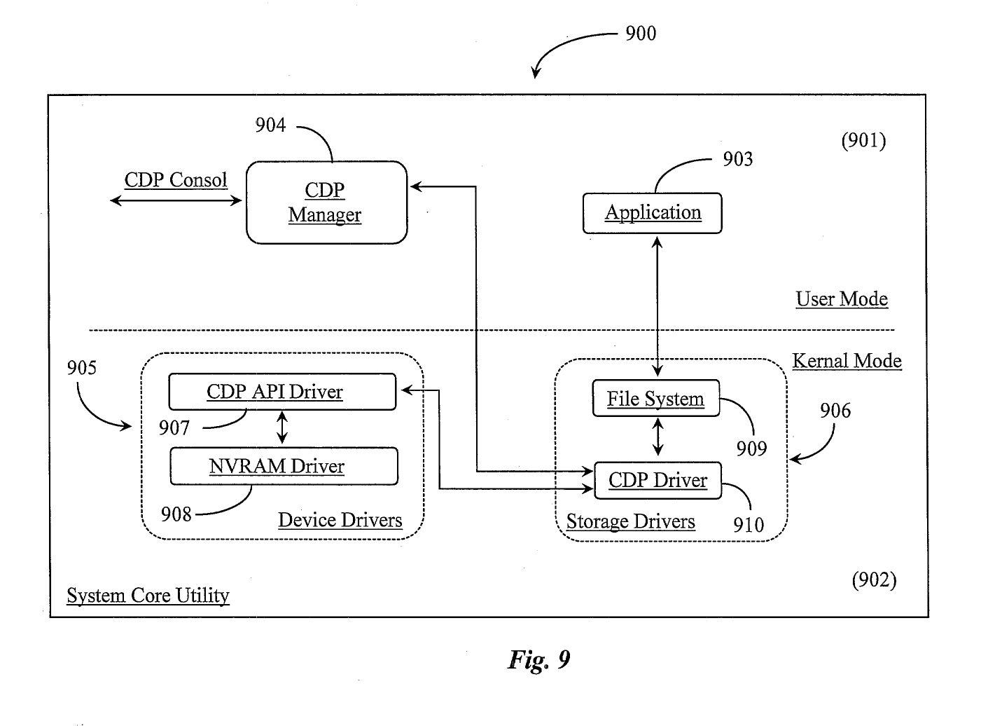

FIG. 9 is a block diagram illustrating a system core utility 900 including core components implemented in software according to an embodiment of the present invention. Utility 900 is exemplary of an operating system kernel and user components associated with kernel software. Utility 900 has a user mode 901 and a kernel mode 902 components. User mode component 901 includes a continuous data protection (CDP) manager 904. Manager 904 communicates with a CDP driver 910 embedded in the system storage driver stack 906. Driver stack 906 may contain additional drivers that are not illustrated in this example.

In user mode an application 903 is running that could be some accounting or transaction application. The application communicates with a file system driver 909 included in a stack of storage drivers 906. The CDP driver 910 communicates with a CDP API driver 907 that provide abstraction layer of communication with variety of persistent memory devices like NVRAM, Flash memory, Magnetic RAM, Solid-state disks and other. The CDP API driver 907 communicates with a specific NVRAM driver 908, also included within drivers 905.

When application 903 writes data via file system driver 909, file system driver issues block level write requests. The CDP driver 910 intercepts them and redirects into persistent memory that services as a write cache. CDP driver diverts the write to the persistent memory via CDP API driver 907 and specific NVRAM driver 908.

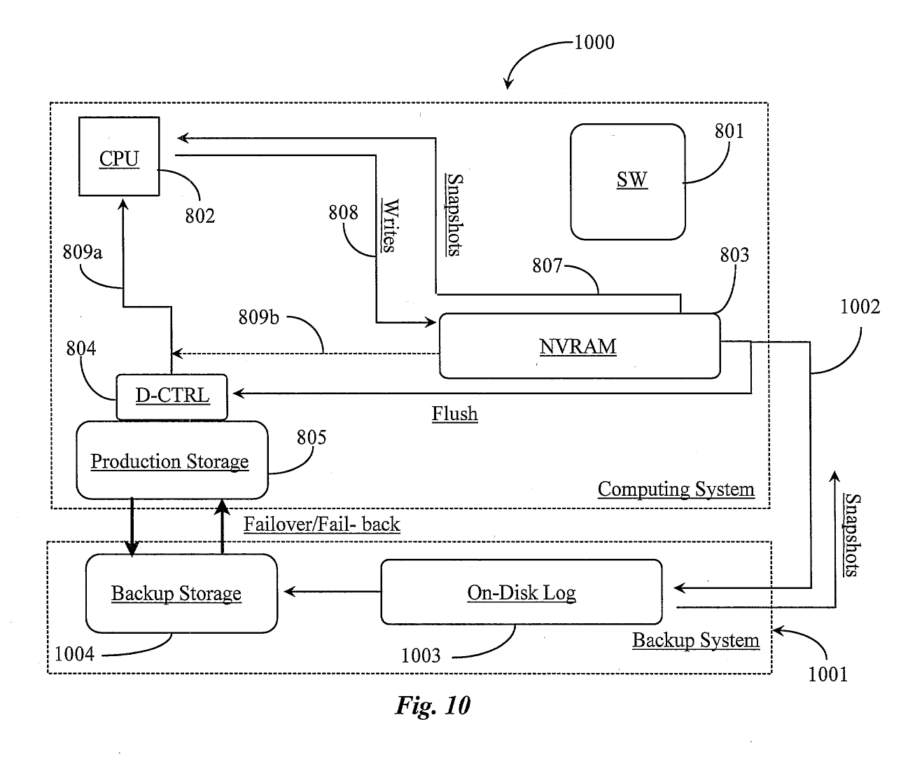

FIG. 10 is a block diagram illustrating the system of FIG. 8 enhanced for local or remote shadow backup and failover procedure according to an embodiment of the present invention. A computing system 1000 is illustrated in this example having many of the same components referenced in FIG. 8 and those components shall retain their same element numbers and description. In this example, computing system 1000 has a connection to a local or remote backup storage system 1001. Backup system 1001 includes a backup storage device 1004 and on-disk log of writes as they were flushed from the NVRAM 803.

System 1001 is provided to backup system 1000 in the case of a production storage failure. System 1001 can be local, remote of both. As a failover system, system 1001 may be located in a different physical site than the actual production unit, as is a common practice in the field of data security. Uniform access to all snapshots whenever created and wherever located is provided on demand. In some embodiments access to snapshots may be explicitly blocked for security purposes or to prevent modifications, etc. One further advantage of snapshot “expose and play” technique is that snapshots do not have to be data-copied from a backup snapshot to production volume. This functionality enables, in some embodiments, co-existence of many full snapshots for a single data volume and that volumes current state. All snapshots are writeable. The approach enables unlimited attempts to locate a correct point-in-time to roll the current volume state to. Each rollback attempt is reversible.

Much as previously described, system 1000 aided by SW 801 may send writes to NVRAM 803. In this example, system 1000 flushes snapshots from NVRAM 803 to production storage 805 through Disk controller 804 over logical path 1002 and at the same time, flushes snapshot copies to on-disk log 1003 within backup system 1001. Backup system can be local or remote. Log 1003 further extends those snapshots to backup storage 1004. Snapshots are available via logical path 807 from NVRAM 803, or from on-disk log 1003. Log 1003 enables recovery of a snapshot and subsequent playing of a log event to determine if any additional changed data logged in between a snapshot should be included in a data recovery task such as rolling back to an existing snapshot.

Backup storage 1004 may be any kind of disk drive including SATA, or PATA. If a failure event happens to system 1000, then system 1000 may, in one embodiment, automatically failover to system 1001 and backup storage 1004 may then be used in place of the production storage disk containing all of the current data. When system 1000 is brought back online, then a fail-back may be initiated. The fail-back process enables re-creation of the most current production storage image without interruption of continuing operation of system 1000. In actual practice backup storage has a lower performance than production storage for most systems therefore performance during the failover period may be slightly reduced resulting in slower transactions.

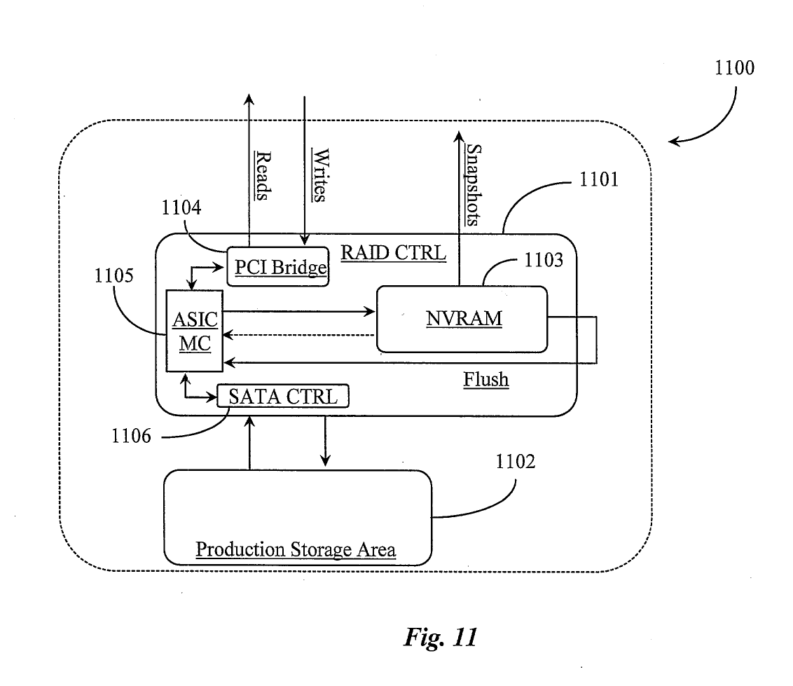

FIG. 11 is a block diagram illustrating a controller 1101 for integrating a computing system 1100 to a redundant array of independent disks (RAID) backup storage system according to an embodiment of the invention. System 1100 is not illustrated with a CPU and other components known to be present in computing systems to better illuminate controller 1101 and controller functionality. In this exemplary configuration RAID controller 1101 is provided with an on-board version of NVRAM 1103. An application specific integrated circuit (ASIC) and microcontroller (MC) combination device 1105 is illustrated as a component of controller 1101 and is known to be available on such RAID controllers. A SATA disk controller is included on controller 1101 and a PCI bridge 1104 is provided on the host side.

The uniqueness of controller 1101 over current RAID controllers is the addition of NVRAM 1103 including all of the capabilities that have already been described. In this case, system 1100 uses production storage 1102, which may be a RAID array accessible to the host through SATA controller 1106. In this case, NVRAM 1103 is directly visible to the CDP API driver (not illustrated) as another type of NVRAM device. It is a hybrid solution where invented software is integrated with PCI pluggable RAID controllers.

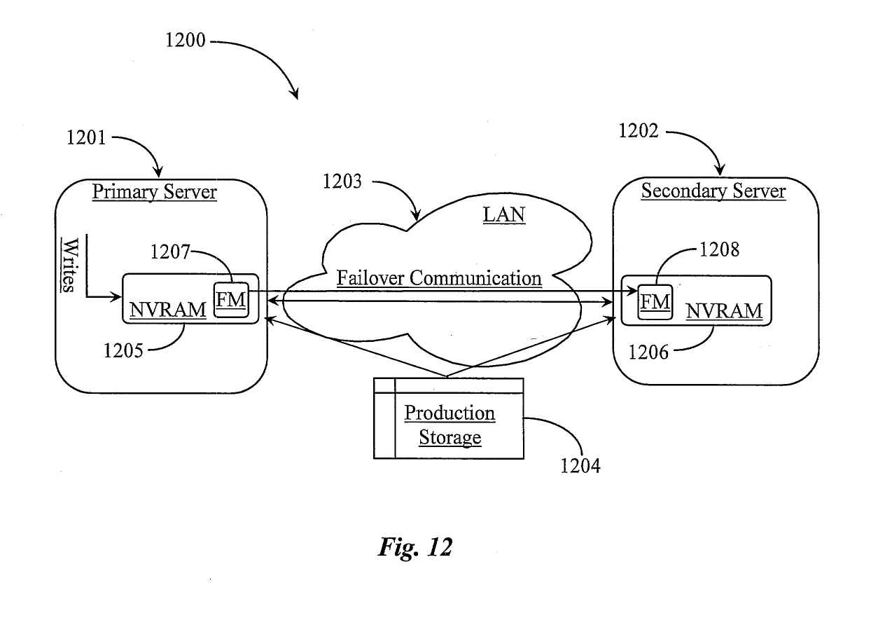

FIG. 12 is a block diagram illustrating connection architecture 1200 for establishing data connectivity between a primary computing system 1201 and backup computing system 1202. Primary server 1201 has an NVRAM memory 1205 and a failover mechanism (FM) 207. In addition, primary server 1201 has a local area network (LAN) connection to a LAN 1203. Secondary server 1202 is similar or identical in some respects in description to primary server 1201. Server 1202 has an NVRAM on-board device 1206. That device also has a failover mechanism 1208 installed thereon.

Both described server systems share a single production storage 1204 that is SAN connected and accessible to both servers, also LAN connected. This is an example of a high-availability scenario that can be combined with any or all of the other examples described previously. In this case the primary production server 1201 is backed up by secondary production server 1202. Production storage 1204 could be a network attached or local storage. In case of the failure of primary server 1201, failover mechanism 1207 transfers the NVRAM 1205 content via a failover communication path over LAN 1203 to secondary FM 1208 using standard TCP/IP protocol or any other appropriate protocols such as Infiniband, or others.

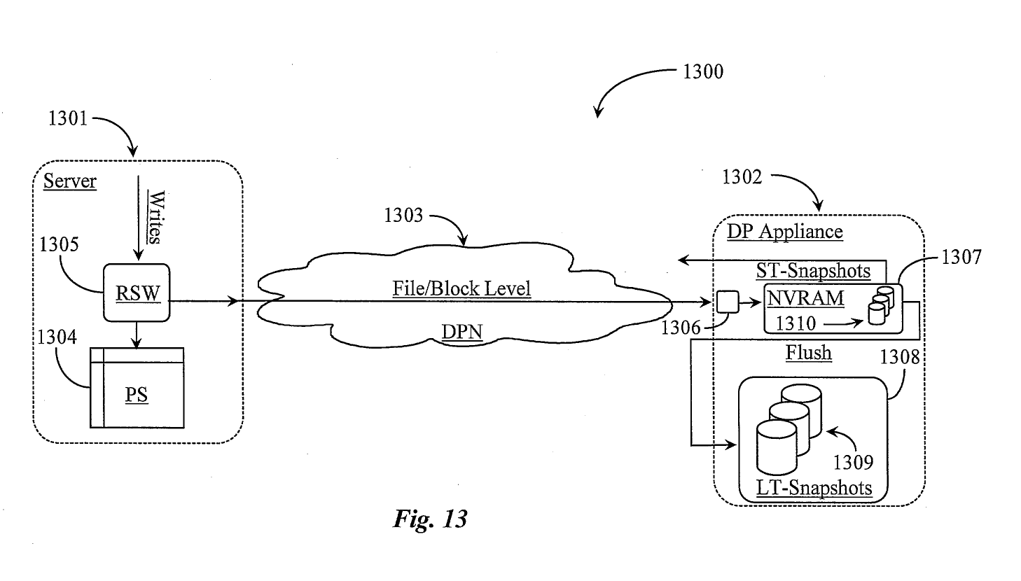

FIG. 13 is a block diagram of a server, workstation, PC or laptop 1301 replicating data for backup by a data protection appliance 1302 enhanced with persistent memory according to an embodiment of the present invention. A data restoration system 1300 encompasses client 1301 and data protection appliance 1302. System 1301 is a standard server, workstation, PC or laptop in this example and may or may not be enhanced with persistent low latency memory. System 1301 has a production storage disk 1304 analogous to other described storage disk options. System 1301 is connected in this example to a data packet network (DPN) 1303. DPN 1303 may be a public or corporate wide-area-network (WAN), the Internet, an Intranet, or Ethernet network.

A third party data replication software (RSW) 1305 is provided to server 1301 for the purpose of replicating all write data. RSW 1305 may be configured to replicate system activity according to file level protocol or block level protocol. Replicated data is uploaded onto network 1303 via a replication path directly to data protection (DP) appliance 1302. Appliance 1302 has connection to the network and has the port circuitry 1306 to receive the replicated data from server 1301. The replicated data is written to NVRAM 1307 or other persistent memory devices like Flash memory or Magnetic RAM. Multiple system snapshots 1310 are created and temporarily maintained as short term snapshots before flush as previously described further above. Simultaneously, data can be replicated to the remote location (not shown on this figure).

In this example, appliance 1302 functions as a host system described earlier in this specification. DP appliance 1302 has a backup storage disk 1308 in which long term snapshots 1309 are stored on behalf of server 1301. In this case, snapshots are available to system 1301 on demand by requesting them over network 1303. In case of a failover condition where system 1301 fails, DP appliance 1302 may recreate the system data set of PS 1304 near-instantaneously from the long term and short term snapshots. Server 1301 may experience some down time while it rolls back to a successful operating state. Unlike the previous example of failover mechanisms, DP appliance 1302 may not assume server functionality as it may be simultaneously protecting multiple servers. However, in another embodiment, DP appliance 1302 may be configured with some added SW to function as a full backup to server 1301 if desired.

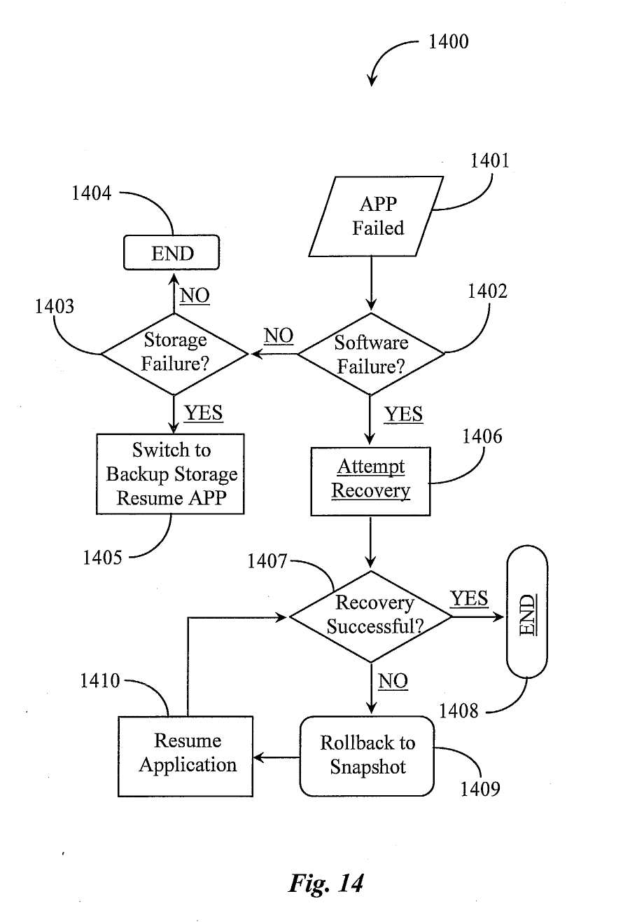

FIG. 14 is a process flow chart illustrating acts 1400 for recovering application server from server hardware or software failure. It can be production storage failure, data corruption, human error, virus attack, etc. Different capabilities such as storage failover or volume rolling back to a last good system snapshot of a computing system are provided according to an embodiment of the present invention. At act 1401 an application running on a protected server has failed and is no longer producing data. At act 1402, it is determined if the failure is due to a software problem. If at act 1402 it is determined that the software has not failed, then in act 1403 it is determined if the failure is due to a storage problem. If at act 1403 it is determined that the storage system has not failed, then the process ends at act 1404.

If at act 1402 it is determined that the failure is not due to software, but the failure is due to a storage failure at act 1403, then at act 1405 the server switches to backup storage and resumes application activity.

If at act 1402 it is determined that the failure is due to a software failure, then at act 1406 the system first attempts recovery without rolling back to a previous system snapshot by calling application specific utilities. At act 1407 the system determines if the recovery attempt is successful. If the attempt proved successful at act 1407, then the process ends at act 1408 without requiring rollback. If at act 1407 it is determined that the recovery attempt is not successful, then at act 1409, the server performs a rollback to a last good system snapshot. Once the system is mounted with the new data and settings then the application is resumed at act 1410.

The process resolves back to a determination of success relative to act 1410 whether or not recovery was successful. If so, the process ends and no further action is required. If not, then the process resolves back to another rollback operation and application restart until success is achieved.

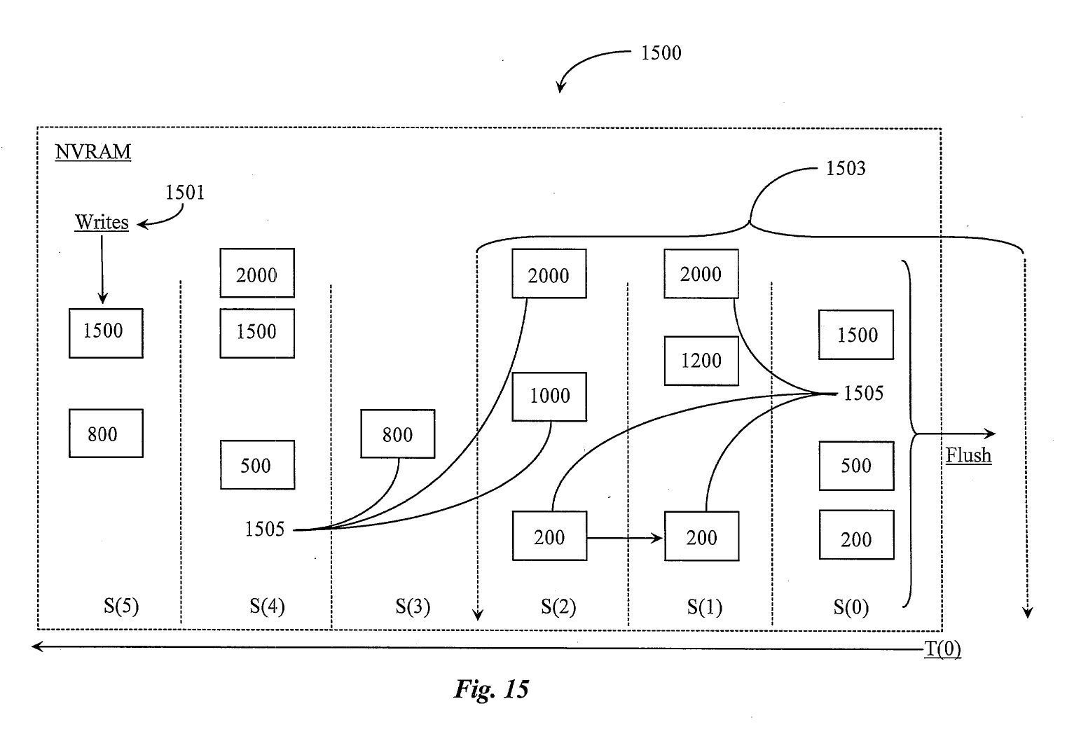

FIG. 15 is a block diagram illustrating a plurality of short term snapshots held in NVRAM 1500 or other persistent memory devices like Flash memory, Magnetic RAM or Solid-state disk according to an embodiment of the present invention. In this exemplary and logical view, NVRAM 1500 contains several short term snapshots of a volume of memory. Snapshots are labeled from S(0) (the oldest snapshot in NVRAM) to S(5) (the most recent snapshot created). A time line extends from T(0) adjacent to a flush threshold representing the state of time-based creation of snapshots. It should be noted herein that trace logging between periodic snapshots can be utilized to provide continuous point-in-time data recovery. In this example, each snapshot is of a pre-set data capacity and is created in a synchronous time frame. That is not specifically required in order to practice the present invention as snapshots may also be manually created at any point in time or they may be created asynchronously (random snapshots). Data pages 1505 represent valid data pages or blocks in NVRAM. Blocks 1505 have volume offset values attributed to them to logically represent the starting address or pointer distance from a specific volume start point in the system volume represented. This is where the page start address is located in the volume and represented in the snapshot. In this example, each snapshot exhibits one or more “dirty” pages of valid data.

Writes 1501 are occurring in data block with the volume offset 1500 in the most recent snapshot. Data block with volume offset 1500 may exist in one of previous snapshots (in snapshot S(4) in this example). However, new page will be allocated in NVRAM in order to preserve snapshot S(4). The data in the block with volume offset number 2000 in S(1) may be different from or the same as the data written in the same block represented in S(2), or in S(4). The only hard commonalities between the data blocks having the same offset numbers are the page size and the location in the volume. When appropriate, the oldest snapshot will be flushed out of NVRAM 1500 and onto a storage disk. This may happen in one embodiment incrementally as each snapshot is created when NVRAM is at a preset capacity of snapshots. A history grouping of several snapshots 1503 may be aggregated and presented as a snapshot. The amount of available snapshots that may be ordered for viewing may be a configurable parameter. There are many different options available for size configuration, partial snapshot view ordering, and so on. For example, a system may only require the portions of a snapshot that are specific to volumes used by a certain application. Application views, file system views and raw data block views may be ordered depending on need.

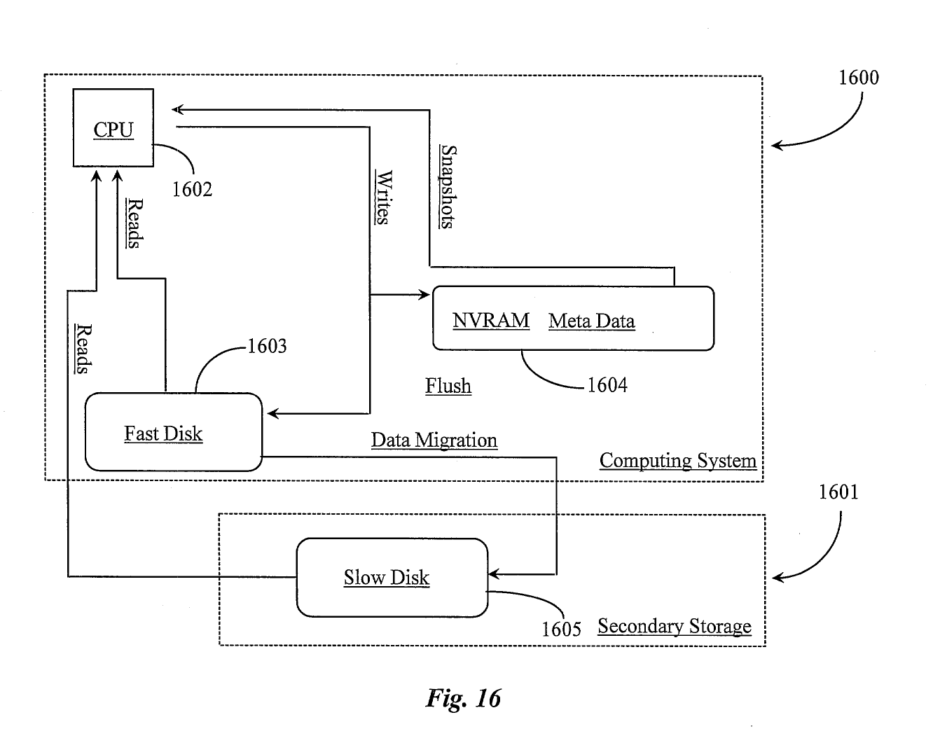

FIG. 16 is a block diagram illustrating a computing system 1600 enhanced with persistent memory 1604 and integrated to a secondary storage system 1601 according to another embodiment of the present invention. System 1600 has a NVRAM persistent memory 1604, a CPU 1602, and a fast disk production storage 1603 like a SCSI or serial attached SCSI (SAS). CPU 1602 may write to NVRAM 1604 which may create snapshots that are available to CPU 1602 as previously described. Secondary storage system 1601 has a slow backup disk like a SATA hard disk. In this data migration scenario, data slowly trickles out of fast disk 1603 into slow disk 1605 via a data migration path or channel during moments when fast storage 1603 is not used by the production system. In this example meta-data is held in NVRAM, and some data, typically the most recent data, is held on fast disk 1603. The mass volume of data is held on slow disk 1605. In some other aspects, this type of slow disk mechanism can also be used to produce hierarchical snapshots according to the following pseudo sequence:

“NVRAM” >to> “Fast” disk/FS >to> “Slow” disk/FS >to> “Remote disk/FS”

This hierarchical approach is additional, and can be separate or together with the enhanced retention method. It is clear that many modifications and variations of this embodiment may be made by one skilled in the art without departing from the spirit of the novel art of this disclosure.

The methods and apparatus of the present invention may be implemented using some or all of the described components and in some or all or a combination of the described embodiments without departing from the spirit and scope of the present invention. In various aspects of the invention any one or combination of the following features may be implemented:
1. Hierarchical snapshots with PLLM and local and remote Snapshot Storage Pools
2. Uniform access to the snapshots wherever located and whenever created
3. Writeable snapshots for application-level consistency and test environment
4. On-Host advanced data protection (CDP, Instant Recovery, unlimited number of “jumps” back and forth in time)
5. Write optimization (coalescing of multiple random writes into single one)
   The spirit and scope of the present invention is limited only by the following claims.

What is claimed is:

1. A host-based system for enhancing performance for a computing appliance, comprising:
a central processing unit;
an operating system;
a long-term disk storage medium; and
a persistent low latency memory (PLLM);
wherein writes to disk storage at random addresses are first made to the PLLM, which also stores a memory map of the disk storage medium, and later made, in sequence, to the disk storage medium according to the memory map.

2. The system of claim 1 wherein the PLLM is one of non-volatile, random access memory (NVRAM), Flash memory, Magnetic RAM, Solid-state disk or any other persistent low latency memory device.

3. A host-based system for continuous data protection and backup for a computing appliance comprising:
a central processing unit;
an operating system;
a long-term disk storage medium; and
a persistent low latency memory (PLLM);
wherein periodic system state snapshots are stored in the PLLM associated with sequence of writes to memory made between snapshots, enabling restoration of the host to any state of a prior snapshot stored in the PLLM, and then adjustment, via the record of writes to memory between snapshots, to any state desired between the snapshot states.

4. The system of claim 3 wherein the PLLM is one of non-volatile, random access memory (NVRAM), Flash memory, Magnetic RAM, Solid-state disk or any other persistent low latency memory device.

5. A method for improving performance in a computerized appliance having a CPU and non-volatile disk storage, comprising steps of:
(a) providing a persistent low-latency memory (PLLM) coupled to a CPU and to the non-volatile disk storage;
(b) storing a memory map of the non-volatile disk storage in the PLLM;
(c) performing writes meant for the disk storage first to the PLLM; and
(d) performing the same writes later from the PLLM to the non-volatile disk, but in a more sequential order determined by reference to the memory map of the disk storage.

6. The method of claim 5 wherein the PLLM is one of non-volatile, random access memory (NVRAM), Flash memory, Magnetic RAM, Solid-state disk or any other persistent low latency memory device.

7. A method for improving performance in a computerized appliance having a CPU and non-volatile disk storage, comprising steps of:
(a) providing a persistent low-latency memory (PLLM) coupled to a CPU and to the non-volatile disk storage;
(b) storing periodic system state snapshots in the PLLM; and
(c) noting sequence of writes to the PLLM for time frames between snapshots, enabling restoration to any snapshot, and any state between snapshots.

8. The method of claim 7 wherein the PLLM is one of non-volatile, random access memory (NVRAM), Flash memory, Magnetic RAM, Solid-state disk or any other persistent low latency memory device.
